(19) United States
(12) Patent Application Publication
(10) Pub. No.: US 2004/0223839 A1
(43) Pub. Date: Nov. 11, 2004

(54) Apparatus and method for product palletizing

(76) Inventor: Donald J. Simkowski, Loveland, CO (US)

Correspondence Address: THE LAW FIRM OF HARRIS & BURDICK, HAROLD BURDICK AND ROBERT HARRIS, 6676 GUNPARK DRIVE, SUITE E, BOULDER, CO, 80301

(21) Appl. No.: 10/434,957

(22) Filed: May 9, 2003

(51) Int. Cl. B65G 57/22

(52) U.S. Cl. 414/791.6

(57) ABSTRACT

Apparatus and method for palletizing of products, such as containers or cases, including dividing of received products into separate paths, orienting the products in one path relative to the products in the other path by rotating the products in one path, and then diverting the oriented products in both of the paths to a plurality of outputs to enable providing a layer of products having a desired pattern when transferred to a pallet. The received products are divided into separate paths and are diverted to a plurality of paths utilizing movable pads having a plurality of slats with adjacent ones of the slats being connected and with one of the slats having a pin extending therefrom to be received in a selected path formed in a path determining unit having gates associated therewith. A control unit is utilized to determine and control movement of product through the apparatus.

### FIELD OF THE INVENTION

This invention relates to an apparatus and method for palletizing of products, and, more particularly, relates to controlled movement of products to enable formation of a layer of products to be transferred to a pallet.

### BACKGROUND OF THE INVENTION

It is oftentimes necessary to move and/or store products, including products, such as container cases or packages, and it has also been found necessary to palletize products by layer in connection therewith.

Apparatus and/or methods are now known for palletizing products, and it is now known, for example, that palletizing of articles by tiers can be effected using a conveyor to transfer products in single file to a lane forming station, outputting plural lanes from the lane forming station to a turning station where selected products in each lane can be rotated using elements to contact the sides of the products being rotated to turn the selected products, and then collecting the products in each of the lanes and transversely repositioning the lanes with respect to one another to form the tiers to be transferred to a pallet (see, for example, U.S. Pat. No. 5,320,478 to Gonsowski, et al.).

### SUMMARY OF THE INVENTION

This invention provides an improved apparatus and method for palletizing of products transferred by layer to a pallet, with the apparatus being efficient and dependable, as well as providing improved handling of the products, including selective orienting of the products without requiring utilization of side contact with the products to effect rotation of the products, diverting of oriented products to a plurality of outputs for forming a layer to be transferred to pallet, and/or transfer of more difficult products, such as, for example, beverage containers or the like that are shrink-wrapped without use of a case.

The products are transferred in lanes, preferably dual lanes, to plural paths, preferably dual paths, of an orienter where the products on one of the dual paths are rotated, or turned, preferably by approximately ninety degrees, prior to each of the articles on the paths being diverted to any selected one of a plurality of outputs, normally in excess of the dual paths of the orienter, with the outputs being utilized to form a desired layer that is then transferred to a pallet.

It is therefore an object of this invention to provide an improved apparatus and method for palletizing of products.

It is another object of this invention to provide an improved apparatus and method for palletizing of products that includes selective product orientation followed by diverting of the oriented products to form a layer of products to be palletized.

It is another object of this invention to provide apparatus including a product orienter having plural paths through which the products are coupled to rotate the products on one of the product paths, and a product diverter to receive the thus oriented products on the plural paths and divert each of the products from the product paths to any selected one of a plurality of outputs to thereby enable formation of a layer of products to be transferred to a pallet.

It is another object of this invention to provide an improved apparatus and method for product palletizing that includes controlled conveying of the products to first and second paths, rotation of the products in one of the paths relative to orientation of the products in the other of the paths, diverting the oriented products in the two paths to a plurality of outputs, and forming a layer of products from the plurality of outputs.

With these and other objects in view, which will become apparent to one skilled in the art as the description proceeds, this invention resides in the novel construction, combination, arrangement of parts, and method as hereinafter described, and more particularly defined by the appended claims, it being understood that changes in the precise embodiments of the invention are to be included as come within the scope of the claims.

### BRIEF DESCRIPTION OF THE DRAWINGS

The accompanying drawings illustrate complete embodiments of the invention according to the best mode so far devised for the practical application of the principles thereof, and in which:

FIGS. 1A and 1B, taken together, provide a top view of the apparatus of this invention;

FIG. 2 is a broken-away top view particularly illustrating the main board of the path defining unit of the lane forming station shown in FIG. 1A;

FIG. 3 is a perspective view of a movable pad shown in FIGS. 1A and 1B;

FIG. 4 is an end view of the movable pad shown in FIG. 3;

FIG. 5 is a top sketch illustrating transverse movement between adjacent pads shown in FIG. 3;

FIG. 6 is broken-away bottom view particularly illustrating the return board of the path defining unit of the lane forming station shown in FIG. 1A;

FIG. 7 is a broken-away top view particularly illustrating the main board of the path defining unit of the diverting station shown in FIG. 1A;

FIG. 8 is an enlarged perspective view of the main board of the path defining unit board shown in FIG. 7; and

FIG. 9 is a broken-away bottom view particularly illustrating the return board of the path defining unit of the diverting station shown in FIG. 1A.

### DESCRIPTION OF THE INVENTION

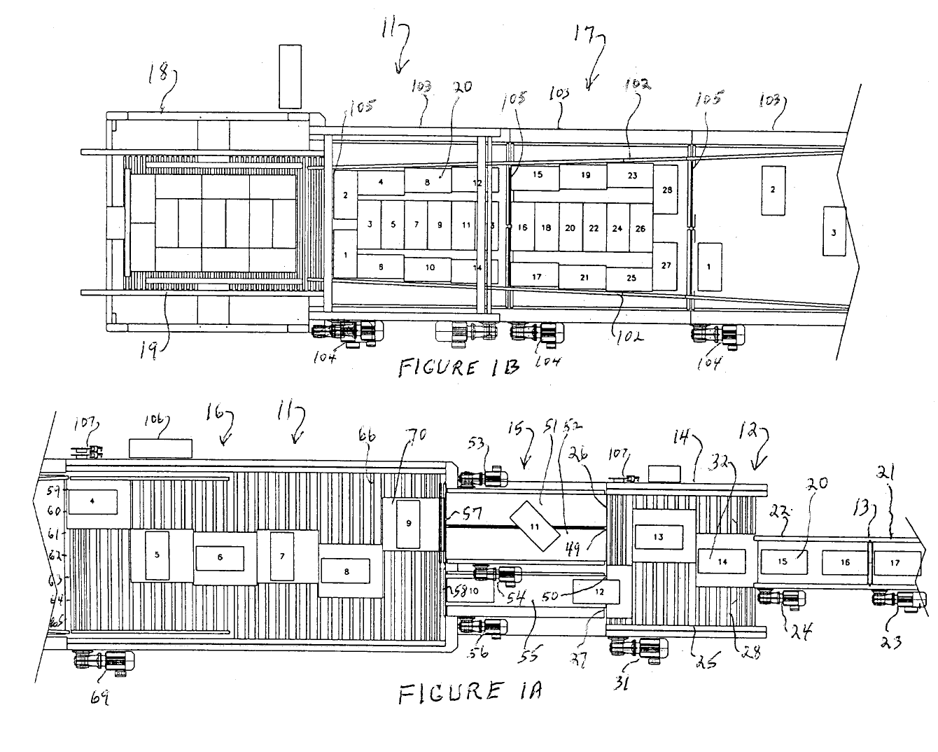

As shown in FIGS. 1A and 1B of the drawings, apparatus 11 of this invention includes an input, or input station, 12 having an infeed conveyor 13 and a lane forming station, or lane former, 14, an orienter, or orienting station, 15, a diverter, or diverting station, 16, a forming, or layer forming station 17, and a hoist 18 having a pallet 19 positioned thereat.

Products 20 received at input station 12 may be a case of products, as generally indicated in the drawings, but may also be products formed, for example, by a grouping of containers, such as beverage containers or the like, with each grouping of containers packaged by a shrink-wrap material with or without use of a separate full or partial case to form the product to be palletized.

As shown in FIG. 1A, products 20 received at input station 12 are received in single file, or line, at infeed conveyor 13, preferably formed by braking conveyor, or belt, section 21 receiving the input of products and accelerating conveyor, or belt, section 22 receiving the products from the braking conveyor section and providing a single output line of products. The infeed conveyors are driven by motors 23 (braking conveyor section) and 24 (accelerating conveyor section). Motors 23 and 24 are preferably variable frequency drive (VFD) motors, as are all of the other motors described in this application.

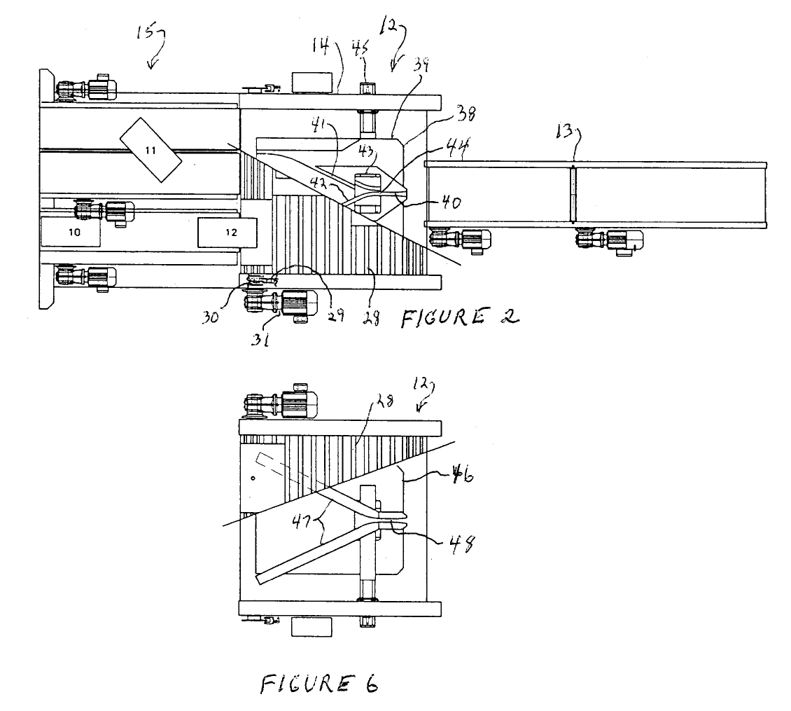

Lane forming station 14 receives the single output line of products from input station 12 and has a divider, or dividing section, 25, as shown in FIG. 2, to divide the single line input of products into first and second (or dual) output lines 26 and 27 of products from the lane forming station.

Dividing section 25 includes a plurality of rods 28 mounted, as illustrated in FIG. 2, at opposite ends on longitudinally extending chains 29 rotated about sprockets 30 with one of the sprockets being rotatively driven by motor 31 to move the upper portion (i.e., the main run) of the rods in the longitudinal downstream direction.

A plurality of movable pads, or pucks, 32 are mounted on rods 28 and are constrained to movement with the rods in the longitudinal directions. Each of pads 32 has a top portion to receive and engage the bottom portions of products to be moved in the downstream direction.

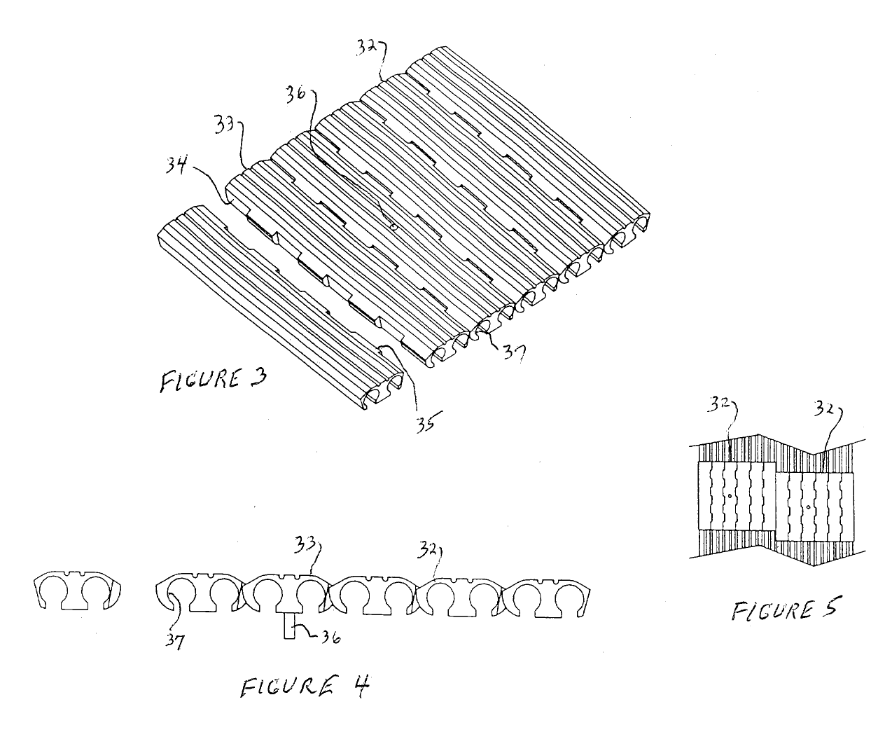

As best illustrated in FIG. 3, each pad 32 is formed from a plurality of slats 33 (six being indicated by way of example in the drawings) with each of the slats being connected at adjacent transversely extending edges 34 by connectors 35, and, as shown in FIGS. 3 and 4, one of the slats has a pin, or rod, 36 extending therefrom with the pins extending between and beyond adjacent ones of rods 28 (i.e., extending vertically from the pads during the main and return runs of rods 28).

As indicated in FIGS. 3 and 4, each pad 32 is mounted on rods 28 by downwardly facing connectors 37 that clamp onto each rod. As indicated, in FIG. 5, each pad 32 is also movable in transverse directions with respect to one another.

Pins 36, extending from one of slats 33 of each of the pads, are received in paths established by path defining unit 38. Path defining unit 38 includes a board, or plate, 39 positioned below the main run of rods 28, and, as indicated in FIG. 2, has an input path 40 therein connectable with a pair of output paths 41 and 42 (all of the paths are formed as openings, or notches, in board 39 to receive pins 36 therein).

A gate 43 is positioned at junction 44 between the input path and the pair of output paths on board 39 of the path defining unit with the gate being actuated by solenoid actuated air cylinder 45 to cause pins 36 to follow a selected one of output paths 41 and 42 to thereby cause each pad to follow one of the two output paths and thereby divide the products into two paths for output of the products from the lane forming station (where the received products are of like orientation in single file and are to be divided into dual paths having products of like orientation, dividing of the products can be achieved by switching positioning of the gate for each successive one of the products, or, alternately, directing the outputs of two infeed conveyors to the orienter).

Path defining unit 38 also includes a second board, or plate, 46 positioned above the return run of rods 28. As shown in FIG. 6, board 46 has converging arms 47 to receive pins 36 of each pad 32 therebetween and direct the pins to a center path 48 during movement of rods 28 (and pads 32) in the longitudinal upstream direction during the return run of rods 28.

Orienting station 15 receives, as inputs, the products from dual outputs 26 and 27 of lane switching station 14 at first and second (or dual) paths 49 and 50. First path 49 includes a pair of adjacent conveyors 51 and 52 positioned side-by-side (with the main run of conveyors 51 and 52 preferably being slightly raised from the inner edges adjacent to one another to the outer edges so that the conveyors form a shallow trough) to commonly receive products from output 26 of the lane switching station. Conveyors 51 and 52 (normally belts rotatively driven about rollers) are driven by motors 53 and 54, respectively, at different speeds so that the products on path 49 are rotated by ninety degrees while moving along conveyors 51 and 52, as is indicated in the drawings. Second path 50 includes a single conveyor 55 (normally a belt rotatively driven about rollers) driven by motor 56 for moving the products along the second conveyor without being rotated and at a speed such that the products reach the output of the second conveyor sufficiently later (or earlier if desired) to allow the products to be handled by the diverting station 16.

The dual outputs of products from orienting station 15 are separately received at inputs 57 and 58 (i.e., input positions) at diverting station 16 with the products received at one input being differently oriented relative to the products received at the other input (i.e., the products received from path 49 of the orienting station are rotated by ninety degrees with respect to the products received from path 50 of the orienting station) and each of the products received at inputs 57 and 58 of the diverting station are transferred by a product mover, or diverter, as brought out hereinafter, to any selected one of the outputs (i.e., output positions) of the diverting station (up to seven outputs 59 through 65 as indicated by way of example in the drawings).

Product is provided in timed sequence to the diverting station from either of paths 49 and 50 of orienting station 15 depending upon the orientation of the products as needed for the particular layer pattern to be achieved at the layer forming station. To achieve the layer pattern shown by way of example in FIGS. 1A and 1B, the first three products (numbered 1, 2, and 3), as well as the fifth product (numbered 5), were transferred to the diverting station from path 49 of the orienter (i.e., rotated) while the fourth and sixth products (numbered 4 and 6) were transferred to the diverting station from path 50 of the orienter (i.e., non-rotated).

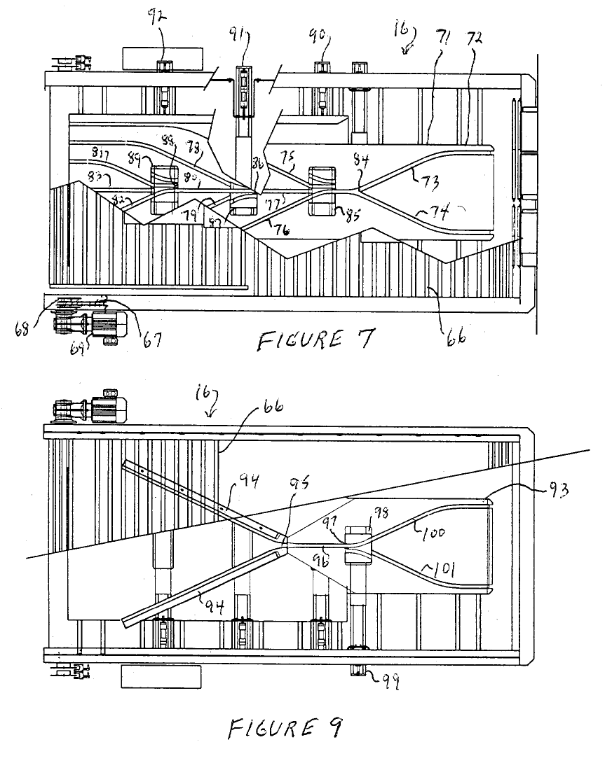

Diverting station 16 includes a plurality of transversely extending rods 66 mounted, as illustrated in FIG. 7, at opposite ends on longitudinally extending chains 67 rotated about sprockets 68 with one of the sprockets being rotatively driven by motor 69 so that the main run of rods 66 is in the longitudinal downstream direction when motor 69 is operating.

A plurality of movable pads, or pucks, 70 (indicated in the drawing by of example as twelve movable pads) are mounted on rods 66 and constrained to movement along with rods 66 in the longitudinal directions. Each pad 70 has a top portion to receive and engage the bottom portions of products to be moved in the downstream direction.

Each pad 70 is formed like (and preferably is identical to) each pad 32 of the lane forming station and includes a plurality of slats (six as shown by way of example in the drawings) with one of the slats of each pad 70 having a pin, or rod, extending therefrom between and beyond adjacent ones of rods 66. In addition, like pads 32 at the lane forming station, pads 70 are also movable in transverse directions along rods 66 to enable products on pads 70 to be diverted from each of inputs 57 and 58 of the diverting station to any of the then utilized outputs 59 through 65 of the diverting station.

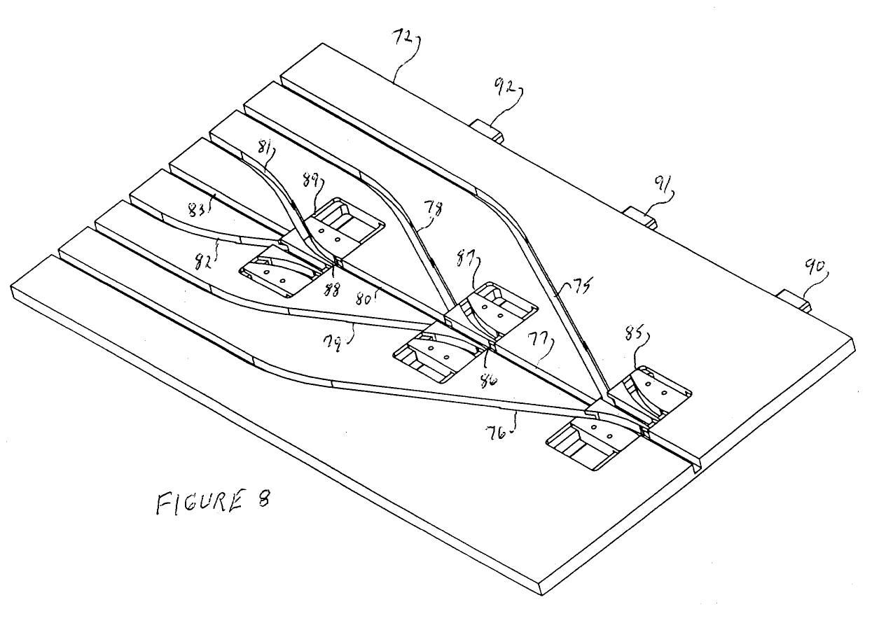

The pins extending from one of the slats of each pad 70 are received in paths established by path defining unit 71. Unit 71 includes a board, or plate, 72 positioned below the main run of rods 66, and, as indicated in FIGS. 7 and 8, board 72 has a plurality of paths 73 through 83 formed in the top side thereof.

Paths 73 and 74 on board 72 are input paths to enable pads 70 to be aligned with either of input positions 57 and 58 receiving products from orienting station 15 with paths 73 and 74 merging at a first junction 84 having a first gate 85 thereafter and also having output paths 75, 76 and 77 extending therefrom (paths 75 and 76 are outside paths leading to output positions 59 and 65 of the diverting station and path 77 is a center path leading to a second junction 86 having a second gate 87 with center path 77 being the only input to second junction 86). Outputs 78, 79, and 80 extend from second junction 86 (paths 78 and 79 are adjacent to paths 75 and 76 and extend to output positions 60 and 64 of the diverting station and path 80 is a center path leading to third junction 88 having a third gate 89 thereat with center path 80 being the only input to third junction 88). Outputs 81, 82, and 83 extend from third junction 88 (paths 81 and 82 are adjacent to center path 83 and extend to output positions 61 and 63 of the diverting station while center path 83 extends to output position 62 of the diverting station).

Three position gates 85, 87 and 89 are controlled by solenoid actuated dual back-to-back air cylinders 90, 91, and 92, respectively, with each of the dual back-to-back air cylinders positioning the gate connected therewith in the left position when both rods of the air cylinders are retracted, positioning the gate connected therewith in the center position when one of the rods is extended while the other rod is retracted, and positioning the gate connected therewith in the right position when both rods are extended to position the gates to enable the pads to be diverted to the desired output.

As best shown in FIG. 8, gates 85, 87, and 89 are three position gates. As illustrated, by way of example, gate 85 is set in the left position so that a pin extending from pad 70 and received at board 72 will follow output path 76 to cause movement of the pad to output position 65 of the diverter station.

In like manner, gate 87 is shown in FIG. 8 to be set in the center position so that a pin extending from pad 70 and received at board 72 will follow center path 80 to cause movement of the pad toward gate 89 (gate 85 must be set in the center position to enable movement of the pin through gate 85 and center path 77 to gate 87).

As also shown in FIG. 8, gate 89 is set in the right position so that a pin extending from pad 70 will follow output path 81 to cause movement of the pad to output position 61 of the diverting station (gates 85 and 87 must be set in the center position to enable movement of the pin through gates 85 and 87 and center paths 77 and 80).

As can be appreciated from the foregoing, by selectively setting the position of each of gates 85, 87, and 89, the pin of each pad received at board 72 will cause product engaged by that pad to be directed to any selected one of the output positions of the diverting station.

Path defining unit 71 also includes a second board, or plate, 93 positioned above the return run of rods 66. As illustrated in FIG. 9, board 93 has converging arms 94 to receive the pins of pads 70 and divert the pins to junction 95 with center path 96 extending from junction 95 to junction 97 having gate 98 thereat, with gate 98 actuated by solenoid actuated air cylinder 99, to divert the pins to one of output paths 100 and 101 so that the pad then being returned to the main run will be at the desired input position 57 or 58 to receive the product the being transferred thereto from the orienting station.

The products at the output positions of the diverting station are transferred to layer forming station 17 where a layer of product is formed from the products received from the then utilized output positions of the diverting station. As illustrated in FIG. 1B by way of example, only three outputs have been utilized for the specific pattern shown. It is to be understood, however, that any number of the provided outputs could be used for the particular pattern to then be established.

As is shown in FIG. 1B, the products are preferably more tightly packed by use of converging guides 102 at the layer forming station with the layer forming station including one or more accumulator sections 98 (shown in FIG. 1B to include three accumulators) with each accumulator section (normally belts rotatively driven about rollers) driven by motor 104 having a stop bar 105 to facilitate forming of each layer of products. After a complete layer of products is formed, each stop bar is withdrawn in a conventional manner and the complete layer is transferred, normally by use of a conventional transfer plate and sweep arrangement, to a pallet 19 on hoist 18. Each complete layer of products subsequently formed is likewise transferred as a separate layer onto the pallet.

Operation of the apparatus is controlled by control unit 106 so that product is continuously transferred through the apparatus, with unit 106 preferably including a programmed computer, with the control unit controlling operation of the motors to cause movement of the conveyors at the input station, orienting station, diverting station, and layer forming station (including transfer of the layer of products to the pallet), as well as control of the solenoids controlling positioning of the gates at the lane forming and diverting stations, positioning of utilized stop bars, and positioning of the pallet on the hoist.

In addition, electronic speed controllers 107 are preferably used to sense the revolutions per minute (rpm) of the conveyor motors at the lane forming and diverter stations to monitor operation of the apparatus.

As appreciated from the foregoing, this invention provides improved apparatus and method for forming a layer of products to be transferred to a pallet.

What is claimed is:

1. An apparatus for transferring products to be palletized, said apparatus comprising:
an input station for receiving products to be palletized and providing received products at first and second outputs;
an orienting station receiving products from said first and second outputs of said input station on first and second product paths each having a separate output with the products at said output of said first path being oriented in a manner unlike that of the orientation of products at said output of said second path;
a diverting station having first and second inputs receiving products from said outputs of first and second product paths of said orienting station, a plurality of outputs, and a product mover for transferring each product received at said first and second inputs to any selected one of said plurality of outputs; and
a forming station receiving products from said plurality of outputs of said diverting station and forming therefrom a layer of products for transfer to a pallet.

2. The apparatus of claim 1 wherein said input station includes an infeed conveyor and a lane forming station providing products at said first and second outputs of said input station.

3. The apparatus of claim 2 wherein said infeed conveyor includes a braking conveyor section and an accelerating conveyor section providing the products to said lane forming station.

4. The apparatus of claim 2 wherein said lane forming station includes a plurality of pads for engaging products received at said infeed conveyor of said input station and a path defining unit for causing movement of said plurality of pads to thereby cause transfer of products engaged by said plurality of pads to said first and second outputs of said input station.

5. The apparatus of claim 4 wherein each of said plurality of pads is formed by a plurality of transversely extending slats connected with one another at adjacent edges with one of said slats having a pin extending therefrom, and wherein said path defining unit has an input path and first and second output paths formed therein to receive said pins thereat to cause said movement of products to said first and second outputs of said input station.

6. The apparatus of claim 5 wherein said path defining unit includes a gate, wherein said input path and said first and second output paths of said path defining unit are connected through said gate, and wherein said path defining unit also includes an actuator for effecting operation of said gate to cause said movement of the products to said first and second outputs of said input station.

7. The apparatus of claim 1 wherein said products received at said first and second paths of said orienting station have like orientations, and wherein said orienting station includes a pair of conveyors at said first path to cause the orientation of the products thereat to be changed by rotation of the products as the products are moved along said first path by said pair of conveyors, and wherein said orienting station also includes a conveyor at said second path to move the products along said second path without changing the orientation of the products.

8. The apparatus of claim 7 wherein said pair of conveyors at said first path are positioned side-by-side and are moved at different speeds to effect rotation of the products on said first path as the products are moved along said first path by said pair of conveyors.

9. The apparatus of claim 1 wherein said product mover of said diverting station includes a plurality of pads for engaging products from said first and second paths of said orienting station and a path defining unit for causing movement of said pads to thereby cause transfer of products engaged by said plurality of pads from each of said paths of said orienting station to said selected one of said plurality of outputs of said diverting station.

10. The apparatus of claim 9 wherein each of said plurality of pads is formed by a plurality of transversely extending slats connected with one another at adjacent edges with one of said slats having a pin extending therefrom, and wherein said path defining unit has a plurality of paths formed therein to receive said pins thereat to cause said movement of products to said plurality of outputs of said diverting station.

11. The apparatus of claim 10 wherein said path defining unit includes a plurality of junctions having gates positioned thereat for directing each of said pins along a path then to be followed, and actuators for effecting operation of said gates to cause said movement of each of the products to a then desired one of said outputs of said diverting station.

12. The apparatus of claim 11 wherein each of said gates has a single input and three outputs connectable with different ones of said plurality of paths for causing said movement of products to said plurality of outputs of said diverting station.

13. The apparatus of claim 1 wherein said forming station includes an accumulator section having at least one stop bar to facilitate forming of said layer of products for transfer to a pallet.

14. The apparatus of claim 1 wherein said apparatus includes a control unit for causing movement of the products through said apparatus.

15. An apparatus for transferring products to be palletized, said apparatus comprising:
an infeed conveyor for providing products to be palletized;
a lane former receiving products from said infeed conveyor and dividing the received products into first and second lanes;
a product orienter for separately receiving products from said first and second lanes of said lane former at first and second paths and turning products on said first path during passage of the products along said first path so that the products on said first path are rotated relative to the products on said second path after passage of the products along said first and second paths;
a product diverter receiving products from said first and second paths of said product orienter and moving each of said products to any selected one of a plurality of outputs;
a layer former for receiving products from said plurality of outputs of said product diverter and forming therefrom a layer of products; and
a pallet receiving said layer of products from said layer former.

16. The apparatus of claim 15 wherein said lane former includes a plurality of pads for engaging products received from said infeed conveyor and a path defining unit for causing movement of said pads to thereby cause transfer of products engaged by said pads to said first and second lanes of said lane former, each of said plurality of pads being formed by a plurality of transversely extending slats connected to one another at adjacent edges with one of said slats having a pin extending therefrom, and said path defining unit having an input path and first and second output paths connected with said input path through a gate with said paths receiving said pins therein, and an actuator for effecting operation of said gate to thereby cause movement of products to said first and second lanes of said lane former.

17. The apparatus of claim 15 wherein said products received at said product orienter have a like orientation, wherein the first path includes a pair of adjacent conveyors receiving the products with one of the conveyors operating at a speed greater than the other one of the conveyors to rotate the products as the products are moved along the first path by said pair of adjacent conveyors, and wherein said second path includes a single conveyor to move the products along said second conveyor without changing the orientation of the products on said second path.

18. The apparatus of claim 15 wherein said product diverter includes a plurality of pads engaging products from said first and second paths of said product orienter and a path defining unit for causing movement of pads to thereby cause transfer of products engaged by said pads from each said paths of said product orienter to said any selected one of said plurality of outputs of said product diverter, each of said plurality of pads being formed by a plurality of transversely extending slats connected with one another at adjacent edges with one of said slats having a pin extending therefrom, and said path defining unit having a plurality of paths formed therein receiving said pins thereat and a plurality of gates and actuators for said gates with said gates being at junctions in said paths for determining the path to be the followed by each said pad to thereby cause said movement of products to any selected one of said plurality of outputs of said product diverter.

19. The apparatus of claim 15 wherein said layer former includes an accumulator section having at least one stop bar to facilitate forming said layer of products.

20. The apparatus of claim 15 wherein said apparatus includes a control unit for controlling movement of the products through the apparatus.

21. An apparatus for transferring products to be palletized, said apparatus comprising:
an infeed conveyor for receiving products and providing output of the products in single file;
a lane forming station having a plurality of movable pads, each having a pin extending therefrom and receiving products from said infeed conveyor, and a path defining unit, having first and second output paths and a gate at said output paths, for causing movement of said movable pads to form dual lanes of products having like orientations;
an orienting station receiving output products from said dual output lanes of said lane forming station, said orienting station including dual conveyors establishing a first product path with said dual conveyors operating at different speeds whereby products are rotated when moved along said first path, and said orienting station also including a single conveyor establishing a second product path whereby products are moved along said second path without rotation of the products;
a diverting station receiving products from said first and second paths of said product orienting station and including a product diverter having a plurality of movable pads each formed by a plurality of transversely extending slats connected to one another at adjacent edges with one of said slats having a pin extending therefrom, said product diverter having a defining unit having a plurality of paths established therein for receiving said pins extending from said plurality of movable pads, and said defining unit including a plurality of junctions each having a gate thereat at said paths for establishing the path to be followed by each of said movable pads to thereby cause products from each of said first and second paths of said orienting station to be transferred to any one of a plurality of outputs with said plurality of outputs being grater in number than said first and second paths of said orienting station;
a layer forming station including an accumulator section having at least one stop bar receiving products from said plurality of outputs of said product diverting station and forming therefrom a layer of products;
a pallet receiving said layer of products from said layer forming station; and
a controller for controlling movement of products through the apparatus including control of said gates to thereby control positioning of said movable pads to thereby control movement of products along said paths of said lane forming station and said diverting station.

22. The apparatus of claim 21 wherein said apparatus repeatedly forms a layer of products, and wherein each said layer of products is separately transferred to a pallet.

23. A method for transferring products to a palletizer, said method comprising:
receiving products to be palletized in single file and dividing received products into two separate paths;
rotating the products in one of said separate paths relative to the products in the other of said separate paths;
receiving products from both of said separate paths and diverting products from both of said separate paths to any one of a plurality of output positions;
forming products from said plurality of products at said output positions into a layer of products; and
transferring said layer of products onto a pallet.

24. The method of claim 23 wherein said step of dividing the products into separate paths includes providing a plurality of movable pads each formed by connected slats one of which has a pin extending therefrom, providing defined separate first and second paths receiving the pins to guide the pads along the separate paths, and providing a controlled gate to effect movement of the pins along a selected one of the first and second paths.

25. The method of claim 23 wherein said step of rotating the products in one of the separate paths includes providing a pair of adjacent conveyors commonly receiving the products with one of the conveyors operating at a greater speed than the other to effect rotation of the products while the products are moved along said adjacent conveyors.

26. The method of claim 23 wherein said step of diverting products from both of the separate paths to any one of a plurality of output positions includes providing a plurality of movable pads each having a plurality of connected slats with a pin extending from one of the slats, providing a plurality of paths having a plurality of junctions with three output paths extending from each of said junctions and with each said path being capable of receiving said pins of said movable pads, and providing controlled gates at each of said junctions for controlling movement of said pins through each of said plurality of paths to thereby control movement of said movable pads and thereby control movement of each of the products to any one of the plurality of outputs.

27. The method of claim 23 wherein said step of forming the products into a layer of products includes accumulating a complete layer of products and then transferring said completed onto a pallet.

28. The method of claim 27 wherein said method includes repeatedly forming complete layers of products and transferring each complete layer onto a pallet.
